(19) United States
(12) Patent Application Publication
(10) Pub. No.: US 2022/0356005 A1
(43) Pub. Date: Nov. 10, 2022

(54) Coffee Capsule with Side Sealed

(71) Applicant: Xiaofeng LIU, Foshan City (CN)

(72) Inventor: Xiaofeng LIU, Foshan City (CN)

(21) Appl. No.: 17/361,337

(22) Filed: Jun. 29, 2021

(30) Foreign Application Priority Data
May 6, 2021 (CN) 202120956620.8

(51) Int. Cl. B65D 85/804

(52) U.S. Cl. CPC B65D 85/804

(57) ABSTRACT

A coffee capsule with side sealed includes a capsule shell for accommodating coffee powder and a sealing film laid on an opening of the capsule shell, and further includes a hoop, tightly hooping an outer side wall of the capsule shell after being compressed under an action force, such that an edge of the sealing film is compressed between the hoop and the outer side wall of the capsule shell, so as to realize connection between the sealing film and the capsule shell to make the coffee capsule. The top surface of the hoop is flush with the top edge of the capsule shell after being compressed. The top surface of the capsule shell is only covered with the sealing film, so that the top surface of the coffee capsule remains smooth and has no step. Therefore, the coffee capsule is easy to adapt to capsule coffee machines on the market.

### TECHNICAL FIELD

The present disclosure relates to the field of coffee capsules, in particular to a coffee capsule with side sealed.

### BACKGROUND

Attribute to the characteristics such as no need of bean grinding, convenient brewing, and good taste and consistent quality after brewing, coffee capsules are well-received. However, because the coffee capsules are disposable, on the one hand, the cost is high, which makes the price high, and on the other hand, a certain degree of waste and environmental destruction are caused. At the same time, coffee machines using coffee capsules cannot use self-ground coffee powder, and such coffee machines are not suitable for consumers who like to grind coffee powder by themselves.

Therefore, there is a coffee capsule that can be repeatedly filled with coffee powder on the market at present, for, example, “a capsule for coffee powder and similar substances” with the patent number CN201020652356.0. However, the coffee capsule of such structure has the following problem: after an annular gland compresses a box body, because the annular gland compresses against a top edge of the box body, the top surface of the annular gland is higher than the film, so there will be a stair between the top surface of the annular gland and the film, which makes the coffee capsule difficult to adapt to a new generation of capsule coffee machines on the market.

### SUMMARY

The present disclosure aims to solve the existing problems mentioned above and provides a coffee capsule with side sealed, which is simple and reasonable in structure and has such an effect that a side of the capsule shell is fixed and sealed through a hoop to keep a top surface of the coffee capsule flat and smooth.

A coffee capsule with side sealed includes a capsule shell for accommodating coffee powder and a sealing film laid on an opening of the capsule shell, and further includes a hoop, tightly hooping an outer side wall of the capsule shell after being compressed under an action force, such that an edge of the sealing film is compressed between the hoop and the outer side wall of the capsule shell, so as to realize connection between the sealing film and the capsule shell to make the coffee capsule.

The present disclosure may also use the following technical solutions:

An inner ring of the hoop is provided with a convex arc surface, and the outer side wall of the capsule shell close to the opening is provided with a concave arc surface matched with the convex arc surface, when the hoop hoops the outer side wall of the capsule shell, the edge of the sealing film is folded downwards and compressed between the convex arc surface and the concave arc surface.

A stop surface obliquely arranged is disposed above the convex arc surface, and an urging surface is disposed above the concave arc surface, and configured to open the hoop when the hoop is compressed and cooperate with the stop surface to tightly clamp the edge of the sealing film after the hoop is compressed.

The outer side wall of the capsule shell is provided with a supporting step surface, and the supporting step surface is disposed below the concave arc surface.

The outer side wall of the capsule shell is circumferentially provided with a plurality of prying openings for detaching the hoop.

An outer flange extends from an outer ring of the hoop.

A diameter at a peak point of the convex arc surface is smaller than a diameter at a junction of the urging surface and the concave arc surface.

A top surface of the hoop is flush with a top edge of the capsule shell after being compressed.

The hoop is detachably connected to the capsule shell.

The hoop is made of a plastic material.

The sealing film includes an aluminum foil.

The present disclosure has the following beneficial effects:

The coffee capsule with side sealed of the present disclosure is simple in structure, convenient to use and low in production cost, and occupies less space. The coffee capsule with such structure can be reused, and a user can add coffee powder in accordance with preferences, and can adjust the proportion at will, thus brewing the coffee desired. In addition, the sealing film is fixed and sealed to the side of the capsule shell by the hoop, and thus the top surface of the capsule shell is only covered with the sealing film, so that the top surface of the coffee capsule remains smooth and has no step. Therefore, the coffee capsule is easy to adapt to capsule coffee machines on the market.

### BRIEF DESCRIPTION OF THE DRAWINGS

FIG. 1 is a schematic exploded structural diagram of the present disclosure.

FIG. 2 is a schematic cross-sectional structural diagram of the present disclosure.

FIG. 3 is a schematic enlarged structural diagram of at A in FIG. 2.

FIG. 4 is a schematic structural diagram of a capsule shell of the present disclosure.

FIG. 5 is a schematic structural diagram of an outer flange of the present disclosure.

### DESCRIPTION OF THE EMBODIMENTS

The present disclosure will be further described below in conjunction with the drawings and embodiments.

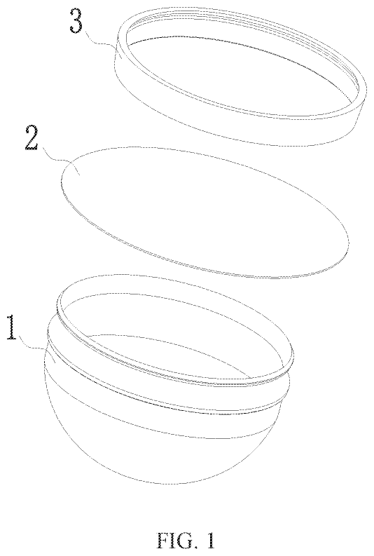

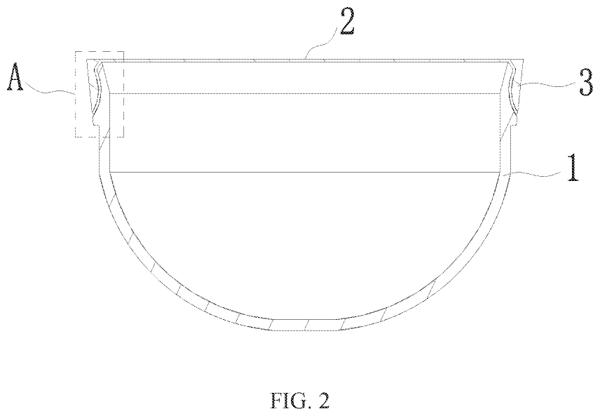

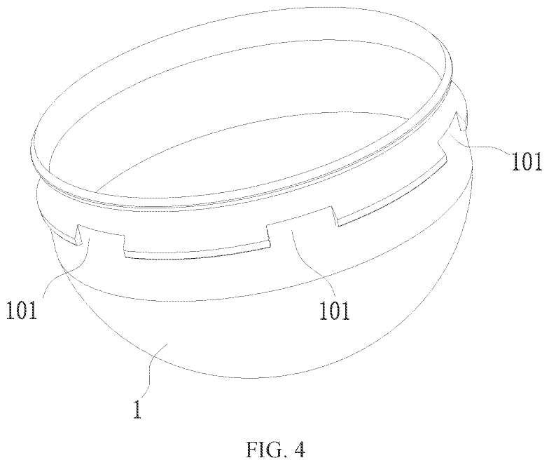

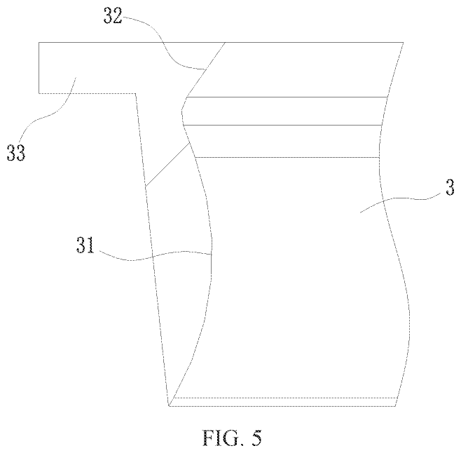

As shown in FIG. 1 to FIG. 5: A coffee capsule with side sealed includes a capsule shell 1 for accommodating coffee powder and a sealing film 2 laid on an opening of the capsule shell 1, and further includes a hoop 3. The hoop 3 tightly hoops an outer side wall of the capsule shell 1 after being compressed under an action force, such that an edge of the sealing film 2 is compressed between the hoop 3 and the outer side wall of the capsule shell 1, so as to realize connection between the sealing film 2 and the capsule shell 1 to make the coffee capsule. The coffee capsule with such structure can be reused, and a user can add coffee powder in accordance with preferences, and can adjust the proportion at will, thus brewing the coffee desired. In addition, the sealing film 2 is fixed and sealed to a side of the capsule shell 1 by the hoop 3, and thus a top surface of the capsule shell 1 is only covered with the sealing film 2, so that a top surface of the coffee capsule remains smooth and has no step. Therefore, the coffee capsule is easy to adapt to capsule coffee machines on the market.

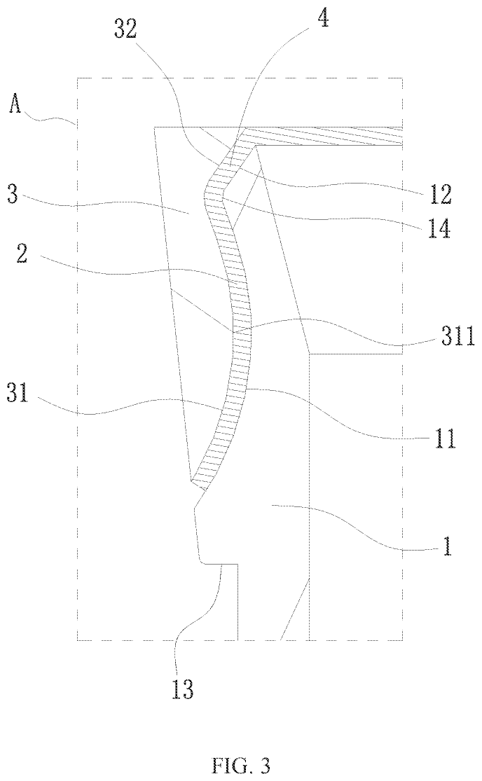

Further, as shown in FIG. 3, an inner ring of the hoop 3 is provided with a convex arc surface 31, and the outer side wall of the capsule shell 1 close to the opening is provided with a concave arc surface 11 matched with the convex arc surface 31. When the hoop 3 hoops the outer side wall of the capsule shell 1, the edge of the sealing film 2 is folded downwards and compressed between the convex arc surface 31 and the concave arc surface 11 (as shown in FIG. 3). Under the cooperation of the convex arc surface 31 and the concave arc surface 11, buckle connection of the hoop 3 and the capsule shell 1 is realized and the hoop 3 is not easy to separate from the capsule shell 1 under an external force.

Furthermore, as shown in FIG. 3, a stop surface 32 obliquely arranged is also disposed above the convex arc surface 31, and an urging surface 12 is also disposed above the concave arc surface 11, and configured to open the hoop 3 when the hoop 3 is compressed and cooperate with the stop surface 32 to tightly clamp the edge of the sealing film 2 after the hoop 3 is compressed. The urging surface 12 is also obliquely arranged. When the edge of the sealing film 2 is clamped between the stop surface 32 and the urging surface 12, the edge of the sealing film 2 is bent and thus form an inclined transition section 4 at the urging surface 12, avoiding the problem that the sealing film 2 is easy to break after the sealing film 2 is bent at a single large angle.

Further, the outer side wall of the capsule shell 1 is provided with a supporting step surface 13, and the supporting step surface 13 is disposed below the concave arc surface 11. When the coffee capsule is compressed, the capsule shell 1 is placed on a mold base with a mold cavity, and the supporting step surface 13 abuts against a top surface of the mold base, so that the capsule shell 1 can be placed stably.

Further, the outer side wall of the capsule shell 1 is circumferentially provided with a plurality of prying openings 101 for detaching the hoop 3. When the coffee capsule needs to be reused, the user can insert a tool (e.g., a straight screwdriver or the like) into the pry openings 101 to pry the hoop out of the capsule shell 3. The structure is simple, and the detaching is convenient.

Further, an outer flange 33 extends from the outer ring of the hoop 3, and the outer flange 33 provides a holding position when the hoop 3 is detached from the capsule shell 1, making the hoop 3 easier to detach.

Further, a diameter at a peak point 311 of the convex arc surface 31 is smaller than a diameter at a junction 14 of the urging surface 12 and the concave arc surface 11, so that the hoop 3 forms an interference fit with the outer side wall of the capsule shell 1 during compression, so as to better position the hoop 3.

Further, a top surface of the hoop 3 is flush with a top edge of the capsule shell 1 after being compressed, so that the top surface of the coffee capsule remains flat.

Further, the hoop 3 is detachably connected to the capsule shell 1 and can be detached for cleaning.

Further, the hoop 3 is made of a plastic material, and the plastic material has certain elasticity.

Further, the sealing film 2 includes an aluminum foil, which is a material commonly used, and is low in use cost.

The above descriptions are the preferred solutions of the present disclosure, which show and describe the basic principles, main features and advantages of the present disclosure. Those skilled in the art should understand that the present disclosure is not limited by the embodiments mentioned above. The embodiments and the descriptions mentioned above only illustrate the principles of the present disclosure, there may be various changes and improvements to the present disclosure without departing from the spirit and scope of the present disclosure, such changes and improvements fall within the scope of protection of the present disclosure, and the scope of protection of the present disclosure is defined by the appended claims and equivalents thereof.

What is claimed is:

1. A coffee capsule with side sealed, comprising a capsule shell for accommodating coffee powder and a sealing film laid on an opening of the capsule shell, and further comprising a hoop, tightly hooping an outer side wall of the capsule shell after being compressed under an action force, such that an edge of the sealing film is compressed between the hoop and the outer side wall of the capsule shell, so as to realize connection between the sealing film and the capsule shell to make the coffee capsule.

2. The coffee capsule with side sealed according to claim 1, wherein an inner ring of the hoop is provided with a convex arc surface, and the outer side wall of the capsule shell close to the opening is provided with a concave arc surface matched with the convex arc surface, when the hoop hoops the outer side wall of the capsule shell, the edge of the sealing film is folded downwards and compressed between the convex arc surface and the concave arc surface.

3. The coffee capsule with side sealed according to claim 2, wherein a stop surface obliquely arranged is disposed above the convex arc surface, and an urging surface is disposed above the concave arc surface, and configured to open the hoop when the hoop is compressed and cooperate with the stop surface to tightly clamp the edge of the sealing film after the hoop is compressed.

4. The coffee capsule with side sealed according to claim 2, wherein the outer side wall of the capsule shell is provided with a supporting step surface, and the supporting step surface is disposed below the concave arc surface.

5. The coffee capsule with side sealed according to claim 1, wherein an outer flange extends from an outer ring of the hoop.

6. The coffee capsule with side sealed according to claim 1, wherein the outer side wall of the capsule shell is circumferentially provided with a plurality of prying openings for detaching the hoop.

7. The coffee capsule with side sealed according to claim 3, wherein a diameter at a peak point of the convex arc surface is smaller than a diameter at a junction of the urging surface and the concave arc surface.

8. The coffee capsule with side sealed according to claim 1, wherein a top surface of the hoop is flush with a top edge of the capsule shell after being compressed.

9. The coffee capsule with side sealed according to claim 1, wherein the hoop is detachably connected to the capsule shell.

10. The coffee capsule with side sealed according to claim 1, wherein the hoop is made of a plastic material.
